(19) United States
(12) Patent Application Publication
(10) Pub. No.: US 2002/0185010 A1
(43) Pub. Date: Dec. 12, 2002

(54) Self supporting coffe filter

(76) Inventor: Antonio Spiteri, Canton, MI (US)

Correspondence Address: Antonio Spiteri, 699 Highlands Dr., Canton, MI, 48188, US

(21) Appl. No.: 09/877,780

(22) Filed: Jun. 11, 2001

(51) Int. Cl. A47J 31/06

(52) U.S. Cl. 99/285; 99/279

(57) ABSTRACT

The present invention relates to filters for coffee,tea or hot brewed beverages, formed of porous paper, in which a substantially fan-shaped filter is placed inside a vessel of a conventional automatic drip beverage brewing appatatus,such as a percolating coffee maker, in which the filter is provided with a set of longitudinal folds, to multiply the rigidity of the filter walls by the ensuing spines formed by folding as supporting members, thus preventing the collapse of the walls while the beverage, such as coffee, is in the brewing process. The folds of the filter are inwardly folded flat while in storage so as to occupy smaller area and to permit its packaging in smaller cartons for easier storage and handling.

### FIELD OF THE INVENTION

This invention relates to filtration devices, and more particularly to home brewing by filtering product through a permeable porous paper, capable of brewing a number of cups of infusion beverages. The present invention relates to a means to prevent the contamination and unwanted weakening of the infusion with unfiltered product that has bypassed the filter.

### OBJECTS OF THE PRESENT INVENTION

An object of the present invention, is to provide a means to prevent a filter from collapsing in its receptacle and allowing unwanted product to pass through unfiltered to the user's cup.

Another object of the present invention is to provide a number pleats to the paper filter sized and shaped to self support the wet walls in its desired upright position, to prevent the filter from collapsing thus water bypassing the infusion grounds weakening the brewed product.

These together with other objects of the present invention, along with the various features of innovation which characterize the present invention, are pointed out with particularity in the appended claims forming parts thereof For a better understanding of the present invention, its operating advantages and the specific objects obtained by the user, references are made to the accompanying drawings and description in which there is illustrated preferred embodiments of the present invention.

### BACKGROUND OF THE INVENTION

Fan shaped filters of the type discussed here serve for making filtered drinks, specially coffee drinks, in a simple way. The self support filter is intended to be used only once and is adapted to be stood on the inside of a vessel such as a coffee basket, portion of a substance for making the drink, an infusion drink such as ground roasted coffee, is introduced into the upwardly open filter The drink is made directly by means of brewing water poured into the filter from above, and the self support filter is then discarded as a whole after the brewing secuence.

Simple handling and cost-efficient production are factors to be taken into account in the construction of filters of this type. It is necessary furthermore, that the filter which unfolds into a three-dimensional shape for the preparation of the drink, initially is folded inwards into a flat configuration occupying a minimal area, an advantage feature for packaging.

Said filter supporting members conventionally consist of folds, formed and contrived on the paper itself, arranged at an angle from the vertical axis, and along the edges of the walls. It is important to place said supporting members so that they provide stiffness to the walls and can likewise be folded together in a flat configuration for packaging, and yet maintain its desired integrity, whereas when opening said fold its ensuing spine retains sufficient rigidity to prevent the walls from sagging when wet.

Many attempts have been made to overcome the problems associated with sagging and drooping of the sidewalls of paper filters. However, prior art coffee filters have suffered from a variety of drawbacks and deficiencies.

### SUMMARY OF THE INVENTION

One of the objects on which the present invention is based is to design a foldable filter of the aforementioned type, so that while maintaining its flexibility yet the rigid properties added by means of folding and pleating the paper, can withstand the sagging moment of said paper when wet. To achieve this object, the sagging resistant filter according to the invention, includes at least a minimum of four folds acting as supporting members, and arranged in pairs at opposite sides of the filter.

In this filter according to the invention, the folded paper acting as supporting members are laid flat on the paper itself in the initial stowed position and to assume the position of use, the folds are open longitudinally relative to the initial position and secured in this supporting position. The filter can thus be placed in the unfolded position inside the coffee maker receptacle ready to accept the coffee grounds to begin the brewing sequence.

The self supporting filter designed in this way requires only a small amount of additional material added to a conventional fan shaped paper filter, to compensate for the pleats and folds, and yet to maintain the same linear and volumetric dimensions when unfolded into said vessel receptacle of said coffee maker.

A further object of this invention is to provide a set of visible indicia means in the form of one or more lines, colored lines, numerals and words, such indicia being affixed on the filter for readily viewing by the user which correspond on the sides of the filter that coincide to the location of said folds as a supporting member.

Other objects, features and advantages of the invention will became apparent on a reading of the specification when taken in conjunction with the drawings in which like reference numerals refer to like elements in displayed views.

### BRIEF DESCRIPTION OF THE DRAWINGS

An exemplary embodiment of the Self Supported Filter according to the invention is explained in detail below with reference to the drawings in which like members bear like reference numerals and wherein:

FIG. 1 is a top view of a Self Supported Filter in a partially folded configuration,

FIG. 2 is an elevation view of a Self Supported Filter in a partially folded configuration

FIG. 3 is a vertical cross-sectional view in the position according to FIG. 1.

FIG. 4 is an isometric view of a Self Supported Filter with the pleats in view in a nearlly unfolded configuration.

FIG. 5 is a cross-sectional view of the filter in its unfold state positioned over the open top of a brew basket.

FIG. 6 is a plan view for forming the filter of the embodiment of FIG. 4

### DETAILED DESCRIPTION OF THE DRAWINGS

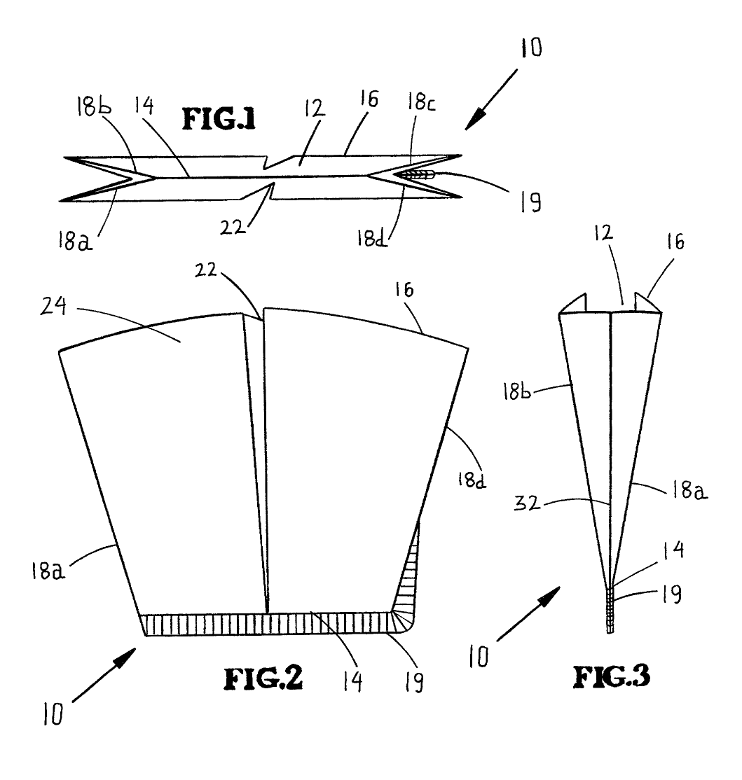

Referring now to the drawings and in particular to FIG. I There is shown a top view of a partially folded filter generally designated 10. The filter of a fan shaped configuration, having a top opening 12, a bottom edge 14, a continuously formed arcuate edge 16, visible indicia related that coincides to ensuing folds 18a, 18b, 18c and 18d. The indicia means may be printed in the form of lines, numerals and words with an acceptable food dye. Additionally the indicia means may be blind embrosed onto the filter material on either side of the surface 24 as shown in FIG. 2. The filter 10 is geometrically configured in size dimension and configuration to be received within the interior or a conventional coffee brewer means such as an electric drip brewer. The fan shaped filter 10 is provided with a bottom region 14 which is sealed by means of bonding and crimping, forming a continuous suture 19.

With reference to FIG. 2 the filter 10 is shown an elevation view includes indicia means marking the ensuing folding edges 18a and 18d, indicia means marking the ensuing center pleat 22, arcuate edges 16 forming the opening 12 as shown in FIG 1, truncated bottom 14, formed of one seamless sector bonded and crimped together along the ensuing seam 19.

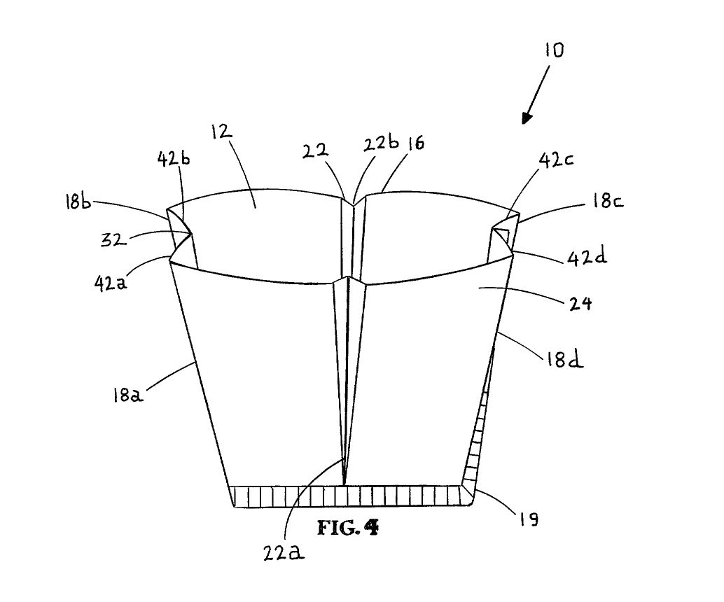

With reference to FIG. 3 the filter 10 is shown in a vertical cross view, includes arcuate edges 16 forming the opening 12, includes indicia marking the ensuing spines by side folds 18a and 18b, center pleat 32, truncated bottom 14 formed of two identical sectors bonded and crimped together along the ensuing seam 19.

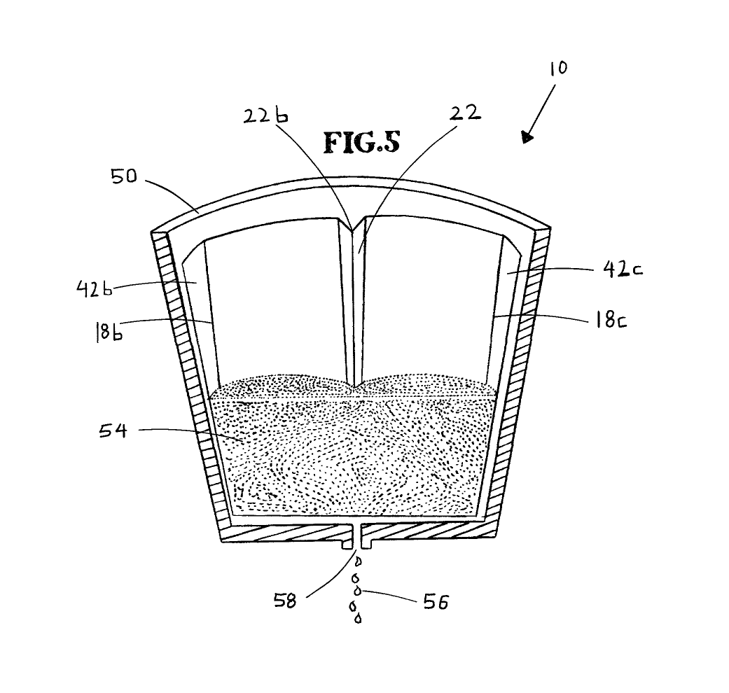

With reference to FIG. 4 the filter 10 is shown an isometric view in a mostly unfolded to deployment configuration. There is an opening 12 to deposit the infusion grounds, arcuate edges 16 and, sidewalls 24 forming a continuous seamless section bonded and crimped together at 19.

A plurality of indicia in the form of lines, numerals and words marking the ensuing spines by folding sides 42a, 42b, 42c, and 42d. When such opposed sides 42a and 42b as well as 42c and 42d are depressed inwardly or toward each other, these ensuing fold lines then became the spines 18a, 18b, 18c and 18d which gradually approach each other until the filter 10 is stored in a flattened state. Furthermore, a set of indicia marking the additional spines 22a and 22b ensuing from pleats 22 on sidewalls 24.

With reference to FIG. 5 the filter 10 is shown a cross section view in its unfolded configuration dimensioned and fit inside the open top of a brew basket 50 having an amount of infusion grounds 54 whereas the infusion liquid 56 has already exit by orifice 58 of said brew basket. A set of indicia marking the ensuing spines 18b and 18c from foldings 42b and 42c An additional se of indicia marking the spines 22a and 22b ensuing from pleat 22.

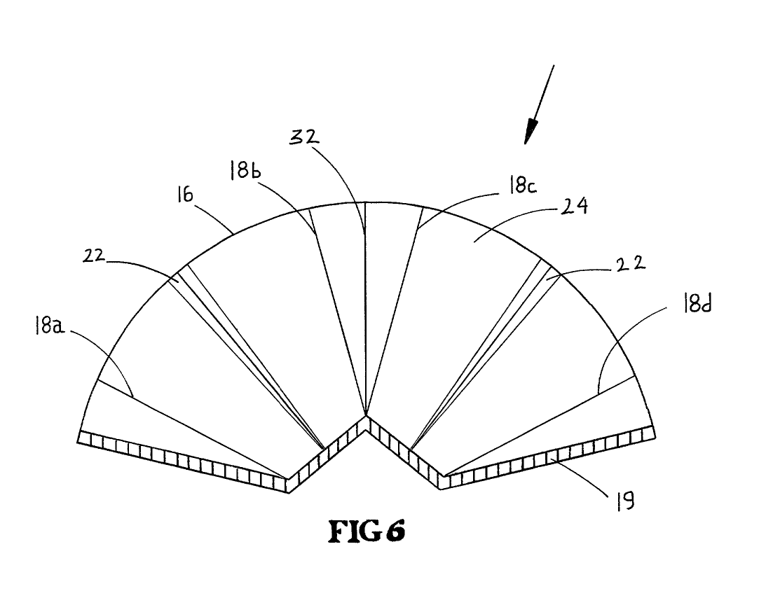

With reference to FIG. 6 the blank for filter 10 includes visible indicia markings being arranged to coincide to folds 18a, 18b, 18, c, 18d, and pleats 22 as supporting members of said filter 10.

As shown in FIG. 6, the blank for fan shaped filter 10 is generally semicircular formed of one continuous sheet of filtering material including sidewalls 24, folds 18a, 18b, 18c, 18c, and 18d, pleats 22, arcuate edges 16 forming the top opening center fold 32, a lower region 14 forming the bottom edge of said filter 10 whereas is bonded and crimped together in one step process along side edge 19.

It should be understood that the preferred embodiments and examples described herein, are for illustrative purposes only and are not to be construed as limiting the scope of the present invention which is properly delineated only in the appended claims.

What is claimed is:

1. A filter for use with a beverage brewing apparatus having a vessel shaped and size for containing fan shaped filter which receives the ground infusion through which hot water passes through the filter and thereafter through aperture means in said container into a beverage vessel, said filter comprising:
a water permeable disposable paper filter, said paper filter having side walls, an open top region an a bottom region, said side walls of said filter having first and second side edges joined together in order to form by crimping said first and second edges together in order to form a continuous side wall of said filter, and
at least four longitudinal folds formed on said side walls acting as supporting members for supporting the filter on the vessel, each of said supporting members being a substantially flat frame that folds inward for storage to occupy minimum area whereas unfolds to conform and adapt to said vessel walls.

2. The filter of claim 1 wherein said fold means is made on the paper walls whereas the ensuing spine having shape retention properties.

3. The filter of claim 1 further comprising additional set of pleats each distant from said side edges.

4. The filter of claim 3 wherein said pleat means are grooved in size and shape to allow for maximum unplyability.

5. The filter of claim 4 wherein said pleat means are grooved in size and shape to allow for minimum size.

6. A filter for use with a beverage brewing apparatus having a vessel shaped and sized for containing fan shaped filter which receives the ground infusion through which hot water pass from a pot or reservoir through the filter and thereafter through aperture means in said vessel into a beverage recipient, said filter comprising:
a water permeable disposable paper filter, said filter having side walls, an open top region and a bottom region, said side walls of said filter having first and second edges joined together in order to form by crimping said first and second side edges together in order to form a continuous side wall of said filter, and
a set of visible indicia imprinted thereon said set including indicia to delimit the pleats to be formed to produce a desired spine to act as supporting member to prevent from saging of said filter walls when weted, wherein said indicia means is printed on the surface of said side walls of said filter and said indicia means is viewable on said filter.

7. The filter of claim 6 wherein said indicia includes lines representative of the pleats and spines associated with the length of said line.

8. The filter of claim 6 wherein said indicia means is embrosed, said embrose is visible to the naked eye.

9. The filter of claim 6 wherein said indicia means is printed with a dye, said dye is visible to the naked eye.
